(19) United States
(12) Patent Application Publication
(10) Pub. No.: US 2002/0195331 A1
(43) Pub. Date: Dec. 26, 2002

(54) Treatment of dental-unit water lines

(76) Inventor: M. Michael Pitts JR., Tucson, AZ (US)

Correspondence Address: ANTONIO R. DURANDO, Durando Birdwell & Janke, P.L.C., 2929 E. Broadway Blvd., Tucson, AZ, 85716, US

(21) Appl. No.: 10/222,521

(22) Filed: Aug. 16, 2002

Related U.S. Application Data
(63) Continuation-in-part of application No. 10/047,493, filed on Jan. 14, 2002.
Application No. 10/047,493 is a continuation-in-part of application No. 09/416,255, filed on Oct. 12, 1999, now abandoned.

(51) Int. Cl. H05F 3/00

(52) U.S. Cl. 204/164

(57) ABSTRACT

A high-voltage capacitive electrostatic device is immersed in the water line feeding equipment in dental offices to remove existing biofilms and to prevent their recurrence. The device is operated continuously in a totally capacitive mode at very high voltages, most preferably greater than 30,000 volts DC. The biofilm present in the system is altered by the electrostatic field so generated and the change is found to cause the separation of existing biofilm from the surface to which it adheres in the water lines and to prevent the formation of new biofilm bacterial colonies, thereby materially improving the quality of the water delivered at the various use points of the dental unit.

### CROSS-REFERENCE TO RELATED APPLICATIONS

This application is a continuation-in-part application of copending U.S. Ser. No. 10/047,493, filed Jan. 14, 2002, which is a CIP of U.S. Ser. No. 09/416,255, filed Oct. 12, 1999.

### BACKGROUND OF THE INVENTION

1. Field of the Invention

This invention generally relates to methods for the electrostatic treatment of water. In particular, the invention describes a method for eliminating and/or preventing the formation of biofilm deposits in dental-unit water-line systems by the application of a high-voltage capacitive electrostatic field.

2. Description of the Related Art

The problem addressed by this disclosure lies in the fact that the water used in dental-unit water lines (DUWLs) is not very clean as a result of deposits, most notably bacterial biofilm deposits, that over time form in the lines. As used herein, the term “dental unit” refers to any assemblage of equipment used in a typical operatory of a dental office, such as water syringes, cuspidors, and dental handpieces. “Biofilms” are defined as matrix-enclosed bacterial populations that adhere to each other and/or to surfaces and pore spaces.

Bacteria produce biofilm growth patterns that are species-specific and create physiologically complex three-dimensional structures, biofilms, that adhere to surfaces, such as the walls of water lines and the pores of filtration elements, and create bacteria-infested colonies. Biofilms and the bacteria within them reach a level of organization that approaches that of a living tissue and include water channels that provide circulation for mass transport of nutrients and removal of wastes. The bacteria within biofilms are often in different metabolic states, with some bacteria exhibiting very little metabolic activity at any given time even in a very active colony. As a result of this condition, biofilms typically exhibit an impressive ability to survive the attack of antibiotics, because the effectiveness of antibiotics is based on their ability to block active bacterial metabolism.

In typical situations, bacterial counts in dental equipment for both “normal” water flora (so-called heterotrophic bacteria) and pathogenic bacteria are far above the limits of what would be considered acceptable for drinking water standards. The maximum drinking-water count recommended by the American Dental Association for heterotrophic bacteria is 200 cfu/ml, while the limit set by the European Union is 100 cfu/ml. Obviously, the present condition represents an unacceptable standard of dental practice and infectious-disease prevention, but it has been tolerated as an unavoidable effect of having dental units connected to conventional utility-water systems. Therefore, there is great interest in finding some way to reduce the bacterial count of the water used while treating dentist patients.

In practice, it is not clear whether dental offices are the source of much (or any) infectious-disease transmission that affects community health because it is difficult to trace the origin of infections and because no rigorous research has in fact been conducted. As knowledge of the dynamics of real-life dentistry has improved, though, and as the understanding of biofilms in this setting has increased, the extent and the ubiquitous nature of DUWL fouling have become apparent. For example, see J. Merritt et al., “Bacterial Biofilm and Dentistry,” Journal of the California Dental Association, May 2001, pp. 347-50; and J. Walker et al., “Microbial Biofilm Formation and Contamination of Dental-Unit Water Systems in General Dental Practice,” Applied Environmental Microbiology, August 2000, pp. 3363-7. The problem was even underscored in a nationwide investigative report entitled “The Dentist's Dirty Secret Tests Reveal Water Dentists Spray Into Patients' Mouths,” which aired on Aug. 4, 2000 (ABC's 20/20).

As the average life span increases with modern medical treatments and better living conditions, more and more people are living with chronic and debilitating diseases, immune system inadequacies, transmissible infectious diseases, and frailty. This population is inherently more at risk from the ravages of infectious diseases, and any exposure to infectious sources should be diligently avoided. Accordingly, it would be unconscionable to tolerate health-care conditions that directly and knowingly contribute to their risk. Thus, the issue of bacterial contamination from DUWLs has become particularly important.

There are identifiable reasons why DUWLs foul more rapidly than conventional potable-water systems. Most importantly, during use of dental-care equipment with a patient, there is direct exposure of each unit to bacteria from the patient's mouth and a corresponding high risk of contamination of both the unit and subsequent patients with the same bacteria. Moreover, because of the very small cross-section of DUWLs and the low intermittent flow-rates of the water flowing through them, the ratio of DUWLs' surface area to water volume is relatively high, which promotes the rapid establishment of biofilm on the interior surfaces of the lines. Once so formed and adhered to the surface of a water line, the biofilm structure protects the bacteria from attack of biocidal agents, which is thought to be the main reason for the persistent and recurrent bacterial colonization of DUWLs. That is, the inability to reach the bacteria in a biofilm matrix makes bacterial eradication nearly impossible.

Various methods used to date to deal with the problem of dental-unit contamination include treatment with chemical/biocidal agents, the use of self-contained water systems, submicron filtration and/or the use of purifiers/sterilizers in the dental-unit water system, and various combinations of these approaches. In practice, each of these solutions has been found to be inadequate as suffering from some or all of the disadvantages of cost, inconvenience to dental-office staff, inability to effectively reach the bacteria contained in biofilm, and/or the development of bacterial resistance to treatment agents.

Thus, all prior attempts at controlling the formation and growth of biofilms in the field of dentistry have been relatively unsuccessful, providing little relief to the pervasive and enduring problem of biofilm formation and the related bacterial fouling of dental-unit water lines. This invention is based on the discovery that high-voltage electrostatic fields applied to the dental-unit water lines essentially prevent the formation of biofilms and promote the separation and removal of existing biofilm deposits. Several prior inventions related to water purification, such as disclosed in U.S. Pat. Nos. 3,933,606, 4,238,326, 4,755,305, 4,802,991, and 4,915,846, have utilized an electric power source to effect water treatment. Others, such as described in U.S. Pat. Nos. 4,024,047, 4,902,390, and 5,326,446, have used electrostatic and electromagnetic fields to purify waters of biological material and bacterial contaminants by reducing their propagation and causing them to settle out.

In particular, U.S. Pat. No. 4,886,593 taught a method for killing or inhibiting the growth of bacteria in water by subjecting them to an electrostatic field, preferably in the presence of a leakage current in the order of several milliamps, which was found to kill the bacteria. The preference for the presence of a leakage current in the order of milliamps is consistent with historical findings in the art of destroying bacteria with electrical phenomena. Since the middle of the last century, the application of electrical currents has been reported to kill bacteria. The bactericidal mechanism was postulated to be the induction of mutations, or some impact of the charge and subsequent cavitation of the bacterial organisms. In 1967, DC pulses up to 25 kv/cm were tested on bacterial suspensions and found to kill a number of bacteria, but as a result of thermal effects rather than electrolysis. The current density ranged from 8 to 61 amps/cm2. See A. J. Sale, “Effects of High Electric Fields on Microorganisms,” Biochimica et Biophysica ACTA 781-788 (1967).

In 1988, a method of reversible breakdown of lipid membranes was reported using current densities in the order of 1 amp/cm2 produced by the application of 0.5-1.9 volts. Cell membranes temporarily lost their barrier function by creating vulnerable hydrophilic pores when exposed to these relatively high electrical potential differences. R. W. Glaser, “Reversible Electrical Breakdown of Lipid Bilayers: Formation and Evolution of Pores,” Biochimica et Biophysica ACTA 275-286 (1988). In 1989, based on experiments with synthetic urine and iontophoresis carried out using 10-400 micro-amps of current, it was determined that the lethality of the current was directly related to the amperage. C. P. Davis, “Effects of Microamperage, Medium, and Bacterial Concentration on Iontophoretic Killing of Bacteria in Fluid,” Antimicrobial Agents and Chemotherapy 442-447 (1989).

Follow-up work in 1991 showed that bacterial and fungal killing could-be accomplished with iontophoretic technology and improved electrodes using up to 400 micro-amps of current. C. P. Davis, “Bacterial and Fungal Killing by Iontophoresis with Long-Lived Electrodes,” Antimicrobial Agents and Chemotherapy 2131-2134 (1991). Using low-intensity electrical fields of 12V/cm2 and low current strengths of 2.1 mA/cm2, Blenkinsopp demonstrated electrical enhancement of biocide efficiency against P. aeruginosa in biofilms in 1992. S. A. Blenkinsopp, “Electrical Enhancement of Biocide Efficacy Against Pseudomonas Aeruginosa Biofilms.” Applied and Environmental Microbiology 3770-3773 (1992). The mechanism was felt to be either electroporation, electrophoresis, or iontophoresis.

In 1994, Davis used a 400 micro-amp current to convert chloride ions present in synthetic urine to chlorine-based substances and concluded that this was the basis for the antimicrobial effect of iontophoresis. C. P. Davis, “Quantification, Qualification, and Microbial Killing Efficiencies of Antimicrobial Chlorine-Based Substances,” Antimicrobial Agents and Chemotherapy 2768-2774 (1994). In 1995, currents of up to 20 mA/cm2 were used to demonstrate that they had no detrimental effect on biofilms, but confirmed that they enhanced the bactericidal performance of tobramycin against P. aeruginosa. J. Jass, “The Effect of Electrical Currents and Tobramycin on Pseudomonas Aeruginosa Biofilms,” Journal of Industrial Microbiology 234-242 (1995). In 1996 Wellman reported an independent confirmation of this bioelectric effect with currents of 1-5 mA/cm2. N. Wellman, “Bacterial Biofilms and the Bioelectric Effect,” Antimicrobial Agents and Chemotherapy 2012-2014 (1996). Later that year, work with 9 mA/cm2 and antibiotics suggested that an electrical current can enhance the activity against biofilms of those antibiotics that are effective against planktonic cells. J. Jass, “The Efficacy of Antibiotics Enhanced by Electrical Currents Against Pseudomonas Aeruginosa Biofilms,” Journal of Antimicrobial Chemotherapy 987-1000 (1996).

Thus, after several decades of experiments with different levels of AC and DC voltages, research has shown that bacteria are most effectively eliminated by currents in the milliamp range and upwards produced by low DC voltages. No one has anticipated or suggested the discovery that a very-high-voltage capacitive electrostatic field alone, in the absence of measurable currents, could be an effective means for treating bacteria. This is especially true in view of the fact that, contrary to expectation, such treatment does not produce a bactericidal effect. In fact, the present invention only produces the weakening and substantial elimination of biofilms and, as a corollary, the substantial eradication of bacterial colonies from water systems. The bacteria are not killed: the biofilms in which they grow are simply dislodged from the surfaces to which they are attached and washed away. Therefore, the invention is particularly suited for cleaning dental-unit water lines where the need for such result has been so clearly demonstrated.

In U.S. Pat. No. 5,591,317, hereby incorporated by reference, I disclosed a new electrostatic device which is operable at very high voltages with reliability and safety. In particular, I demonstrated that such a capacitive device, unlike similar prior-art capacitors, is not susceptible to total breakdown as a result of breakage or interruptions in the dielectric integrity of the material. Given the relatively high voltage at which my capacitive electrostatic device can be safely and reliably operated, I have explored its use for improving other water-related processes such as chemical flocculation, disclosed in my application Ser. No. 09/167,115, and membrane separation, disclosed in Ser. No. 10/047,493. The present disclosure results from expanded research directed at improving the quality of DUWLs by the application of capacitive electrostatic fields produced at the high voltages permitted by devices such as disclosed in U.S. Pat. No. 5,591,317. The invention is based on the discovery that such high-voltage electrostatic fields essentially prevent biofouling and eliminate existing biofilms in water lines without the use of any biocidal agents.

### SUMMARY OF THE INVENTION

The invention generally relates to a method of treating dental-unit water lines with capacitive devices capable of producing high-voltage electrostatic fields. The approach represents a completely new, effective, safe and easily implemented solution to this extremely difficult problem for dental practitioners.

The primary object of the invention is a process and apparatus for removing biofilm deposits present in dental-unit water lines.

Another important object of the invention is a process and apparatus for preventing the formation of biofilm in the water lines of new and treated dental units.

Another important goal is a water treatment process that permits the establishment and maintenance of a planktonic bacteria level below 200 cfu/cc in unfiltered DUWL water, the amount recommended by the American Dental Association.

Another goal of the invention is a capacitive electrostatic device suitable for applying the very high voltages required to implement the invention in a safe, convenient and efficient manner in existing dental units in order to achieve the aforementioned objectives.

Therefore, according to these and other objectives, the main aspect of the present invention consists of utilizing a high-voltage capacitive electrostatic device first in order to remove existing biofilms and then to prevent their recurrence in the water lines of equipment in dental offices. The invention is used in connection with conventional dental units found in dentist offices throughout the world. The device is immersed in the water flowing through the lines feeding the dental equipment and is operated continuously in a totally capacitive mode (i.e, without current flow) at voltages preferably greater than 15,000 volts and most preferably greater than 30,000 volts DC. The charge on the biofilm membranes present in the system is altered by the electrostatic field so generated and is found to cause the separation of existing biofilm from the surface to which it adheres in the water lines and to prevent the formation of new biofilm bacterial colonies, thereby materially improving the quality of the water delivered at the various use points of the dental unit.

According to another aspect of the invention, the preferred embodiment of a capacitive electrostatic device for the invention is a vitrified ceramic tube of unibody construction having a single open end adapted to receive a high-voltage power cable through an insulated cap. This device is disclosed in U.S. Pat. No. 5,591,317. The interior of the ceramic tube is fitted with a conductive element electrically connected to the power cable, thereby providing a relatively-large conductive surface inside the interior dielectric surface of the ceramic tube.

Various other purposes and advantages of the invention will become clear from description provided in the specification which follows and from the novel features particularly pointed out in the appended claims. Therefore, to the accomplishment of the objects described above, this invention comprises the features hereinafter illustrated in the drawings as fully described in the detailed description of the preferred embodiment and as particularly recited in the claims. However, such drawings and description disclose only some of the various ways in which the invention may be practiced.

### BRIEF DESCRIPTION OF THE DRAWINGS

FIG. 1 is an elevational view partially cut-out of a capacitive electrostatic device used in the water treatment of dental unit water lines according to the present invention.

FIG. 2 is a detailed, elevational section of the device shown in FIG. 1.

FIG. 3 is a plan view in section of the device as seen along line 3-3 of FIG. 2.

FIG. 4 is a schematic view of a high-voltage capacitive device inserted in a by-pass line of a conventional dental office water system in order to treat the water lines according to the invention.

FIG. 5 is a time plot of bacterial colony-forming units per milliliter of water measured out of a cold-water faucet in the first operatory of the dental office subjected to the experimental run detailed in Example 1.

FIG. 6 is a time plot of bacterial colony-forming units per milliliter of water measured out of a cuspidor in the same operatory of the dental office subjected to the experimental run detailed in Example 1.

FIG. 7 is a time plot of bacterial colony-forming units per milliliter of water measured out of a handpiece in the same operatory of the dental office subjected to the experimental run detailed in Example 1.

FIG. 8 is a time plot of bacterial colony-forming units per milliliter of water measured out of a high syringe in the same operatory of the dental office subjected to the experimental run detailed in Example 1.

FIG. 9 is a time plot of bacterial colony-forming units per milliliter of water measured out of a cold-water faucet in the first operatory of the dental office subjected to the experimental run detailed in Example 2.

FIG. 10 is a time plot of bacterial colony-forming units per milliliter of water measured out of a cuspidor in the same operatory of the dental office subjected to the experimental run detailed in Example 2.

FIG. 11 is a time plot of bacterial colony-forming units per milliliter of water measured out of a handpiece in the same operatory of the dental office subjected to the experimental run detailed in Example 2.

FIG. 12 is a time plot of bacterial colony-forming units per milliliter of water measured out of a high syringe in the same operatory of the dental office subjected to the experimental run detailed in Example 2.

FIG. 13 is a time plot of bacterial colony-forming units per milliliter of water measured out of a cold-water faucet in the first operatory of the dental office subjected to the experimental run detailed in Example 3.

FIG. 14 is a time plot of bacterial colony-forming units per milliliter of water measured out of a hot-water line in the same operatory of the dental office subjected to the experimental run detailed in Example 3.

FIG. 15 is a time plot of bacterial colony-forming units per milliliter of water measured out of a handpiece in the same operatory of the dental office subjected to the experimental run detailed in Example 3.

FIG. 16 is a time plot of bacterial colony-forming units per milliliter of water measured out of a high syringe in the same operatory of the dental office subjected to the experimental run detailed in Example 3.

### DESCRIPTION OF THE PREFERRED EMBODIMENTS

The development of the high-voltage capacitive electrostatic device disclosed in U.S. Pat. No. 5,591,317 provided the basis for addressing several unsolved problems in the field of water-treatment processes. During the course of this research and development work, collateral discoveries enabled the solution of other problems related to water systems. For example, as disclosed in copending U.S. Ser. No. 09/167,115, the same high-voltage capacitive device was found to improve flocculation processes. Similarly, copending U.S. Ser. No. 10/047,493 describes efficiency gains obtained by applying the high-voltage electrostatic generators to commercial membrane-filtration systems, especially nanofiltration, ultrafiltration and reverse-osmosis systems. This disclosure is based on the discovery that the same capacitive electrostatic fields applied with very high voltages to the water flowing through the lines of dental units found in conventional dentist offices yield remarkable results in removing existing bacterial biofilm from the lines and in the preventing subsequent formation of new biofilm. As a result, the problem of high bacterial count in dental units, which has not been satisfactorily solved to date, has been virtually eliminated.

As those skilled in the art would readily recognize, a true capacitive electrostatic device consists of two electrically charged conductive plates or equivalent structures separated by a dielectric material (i.e., a material that is non-conductive). Once the plates of the capacitor are fully charged as a result of the application of a DC voltage, the capacitor takes the characteristics of an open circuit; that is, an electrostatic field is produced across the plates. No measurable current flow is possible across the dielectric material unless the applied voltage is sufficiently high to exceed the dielectric strength of the material. For the purposes of this disclosure, a “measurable” current is defined as a current that can be measured with conventional amp-meter instrumentation; that is, a current in the order of milliamps, or at least 100 micro-amps. Given the very high voltages used for the present invention (preferably 30,000 volts and higher), any such measurable leakage current would rapidly cause a total dielectric breakdown and a corresponding disabling short of the capacitor. Therefore, all references to capacitive electrostatic devices in this disclosure are intended to refer only to capacitors exhibiting no measurable leakage current, as defined herein, during operation. To ensure that end, the power supplies used to energize the capacitive electrostatic device of the invention are provided with a current-limiting ground fault for interrupting the operation of the power supply in case a current to ground of a few micro-amps is detected. Thus, if a measurable current leak develops in the dielectric material, the device is automatically taken out of service to prevent its destruction.

As used herein, “high voltage” is intended to refer to voltages in excess of the working limits of conventional electrostatic capacitors insulated with a Teflon® layer; that is, voltages above at least 10,000 volts, preferably above 15,000 volts, and most preferably in the 30,000 to 55,000 range. The capacitive electrostatic-field generator used as the preferred embodiment of this invention includes an outer tube made of vitrified ceramic material as the supporting structure of the electrostatic device. The ceramic material functions both as the insulating and bearing structure of the device, thus allowing the application of very high voltages to the electrode. The ceramic tube is formed in unibody construction with a sealed end, thereby eliminating the need for a sealed, dielectric cap at that end. While the development of the vitrified ceramic material disclosed in U.S. Pat. No. 5,591,317 was critical to enabling this invention because of the high voltage required for its implementation, it is understood that any device capable of producing a high-voltage capacitive electrostatic field would be equally suitable.

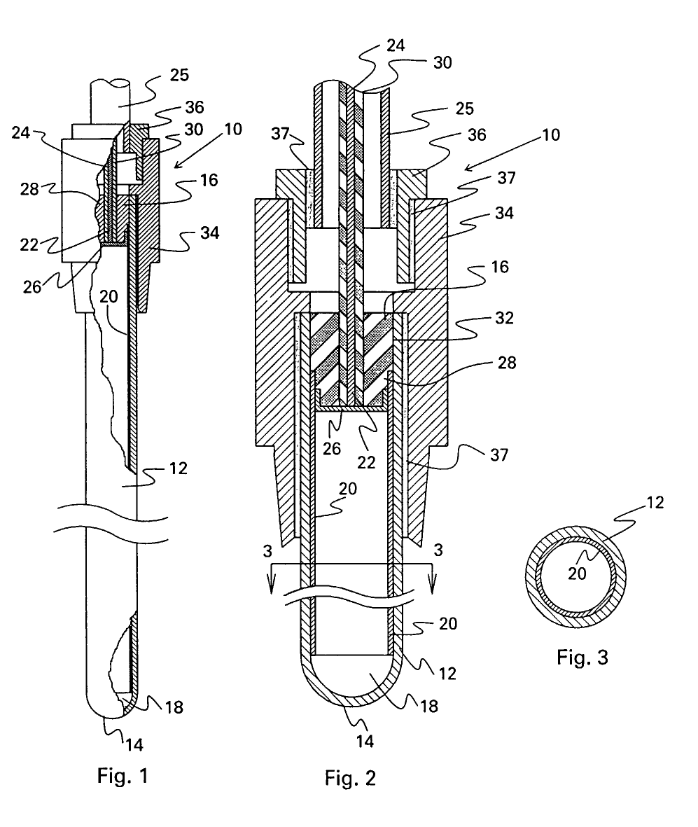

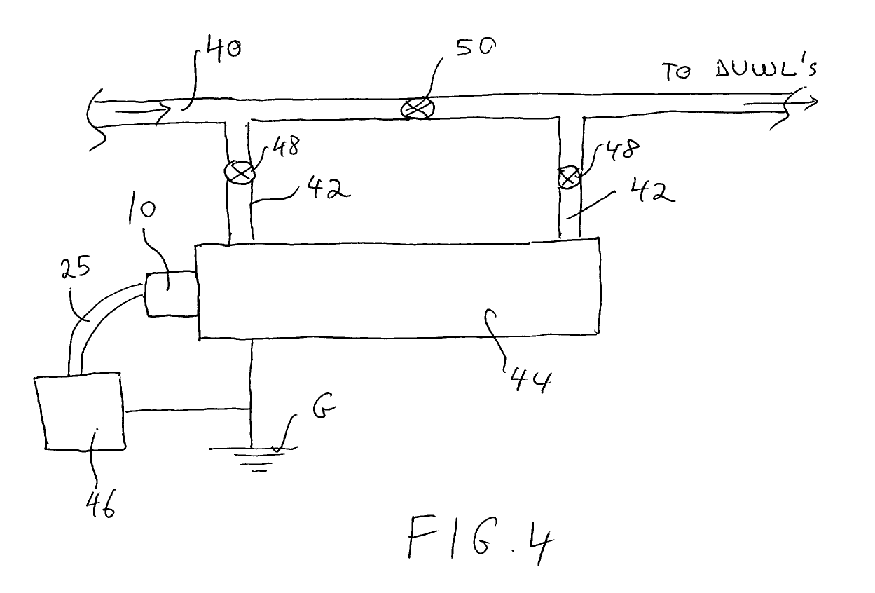

Referring to the drawings, wherein like parts are designated throughout with like numerals and symbols, FIG. 1 is an elevational schematic view the various components of an electrostatic device 10 used advantageously according to the invention to remove biofilm deposits from DUWLs. As also shown in more detail in FIGS. 2 and 3, the device 10 consists of a ceramic tube 12 preferably of unibody construction and having a distal integrally-sealed end 14 and a proximal open end 16. The interior surface 18 of the tube 12 is lined with a layer of conductive material 20, such as aluminum or copper foil, disposed in contact with the surface 18. Depending on the material and process used to coat the interior of the ceramic tube, the inside of the sealed end 14 may or may not also be lined. In the drawings, the inside of the sealed end 14 is not lined. The capacitive effect of the tube is related to the overall surface of the conductive material 20, as one skilled in the art would recognize. Alternatively, as disclosed in the referenced patent, the interior of the tube 12 may be filled with a conductive liquid. I recently discovered that a charged conductive tube or rod inserted into the cavity defined by the interior surface 18 of the tube 12 produces equivalent results.

The end 22 of an appropriately insulated high-voltage cable 24 contained in protective conduit 25 is electrically connected to the conductive material 20 or equivalent conductor inside the tube 12. A conductive bushing 26, attached to the end 22 of the cable and press-fitted or otherwise connected to the conductive material 20 or other conductor, may be used to provide electrical contact between the two, but any equivalent method or device, such as by welding, would be suitable to practice the invention. This electrical connection is shown near the open end 16 of the ceramic tube in the figures, but it could be effected at any place along the inner length of the tube with equivalent results inasmuch as the entire surface of the conductive material 20 or equivalent conductor is obviously energized by the connection. Most importantly, though, the open end 16 must be sealed by nonconductive, preferably resilient, adhesive material 28 such as silicone, latex, or rubber which is tightly packed or molded, such as by potting, between the insulating sheath 30 of the cable and an interior wall of the open end 16. Preferably, an outermost annular portion 32 of the interior wall of the open end 16 is not covered with the conductive material 20 or other conductor housed in the tube, so as to provide a continuous dielectric barrier at that end formed by the nonconductive material 28 filling the space between the cable sheath 30 and the ceramic tube 12. Finally, the open end 16 of the ceramic tube 12 is hermetically capped by a mounting fixture 34 adapted for tight water-proof fit with the end 16 on one side and with a cable connector 36 on the other side. The specific shape and characteristics of the fixture 34 and connector 36 are not important for the invention so long as they are adapted to protect the open end 16 of the ceramic tube from penetration of liquid from the outer body of water in which the device is immersed during use. Thus, the gap between the interior surface of the fixture 34 and the exterior surface of the tube 12 fitted thereto, whether by screwable or other type of engagement, must be perfectly sealed for long-term operation of the device. The same is true for the gap between the interior surface of the fixture 34 and the exterior surface of the connector 36. Silicone or other insoluble, preferably resilient, sealing material 37 may be used to ensure water-tight coupling while making the various connections.

As illustrated schematically in FIG. 4, for the purpose of operation in a dental office's water system, the electrostatic capacitor 10 is immersed in a body of water feeding the water lines of the office's dental units. The body of water is connected to a ground G either directly or through a separate electrode (not shown) immersed in the water at a distance from the device 10 (that is, spanning across the flowing water). The pipe 40 that provides water to the DUWLs in the office from a utility connection is preferably modified by the addition of bypass lines 42 that route the water though a reaction chamber 44. The capacitor 10 is installed in the chamber 44 immersed in the water flowing to the DUWLs. A high-voltage power supply 46 provides the required DC electromotive force to create the electrostatic field necessary to implement the water treatment process of the invention. Two bypass valves 48 in the bypass lines 42 and an additional main valve 50 in the main service line are preferably used to control the water flow through the reactor 44.

In the preferred embodiment of the invention, an 18-inch electrostatic capacitor 10, Model ZR18S, manufactured by Zeta Corporation of Tucson, Ariz., is installed in a grounded reactor chamber 44 that consists of a 3-inch ID tube approximately 25 inches long. A power supply, Model POV, manufactured by Zeta Corporation, operable at 35,000 volts with a ground-fault limit of 140 micro-amps, is connected to the capacitor 10. The bypass system is preferably connected to the main water line to the dental office of interest. In operation, the main valve 50 is preferably closed completely and all water is routed through the reaction chamber via the bypass valves 48.

The process and device of the invention were tested in various dental offices as described in the following examples. The sites were chosen based on the interest of dental practitioners in bacterial DUWL issues and the availability of prior bacterial-culture data from their operatories.

### EXAMPLE 1

A ceramic electrode configured according to the device 10 and a 35 kV DC power supply were installed in January 2002 in a reactor chamber in parallel to the main line feeding the DUWLs of a dental office in the Los Angeles area, Calif. The office includes ten operatories with galvanized piping that has been in service for over 30 years. Analyses of the water sampled at each operatory in 1997 and 2000 had shown heterotrophic bacterial counts varying from about 1,100 to greater than 20,000 cfu/ml (colony-forming units per milliliter of water), the latter number being the maximum count accurately recorded with available instrumentation.

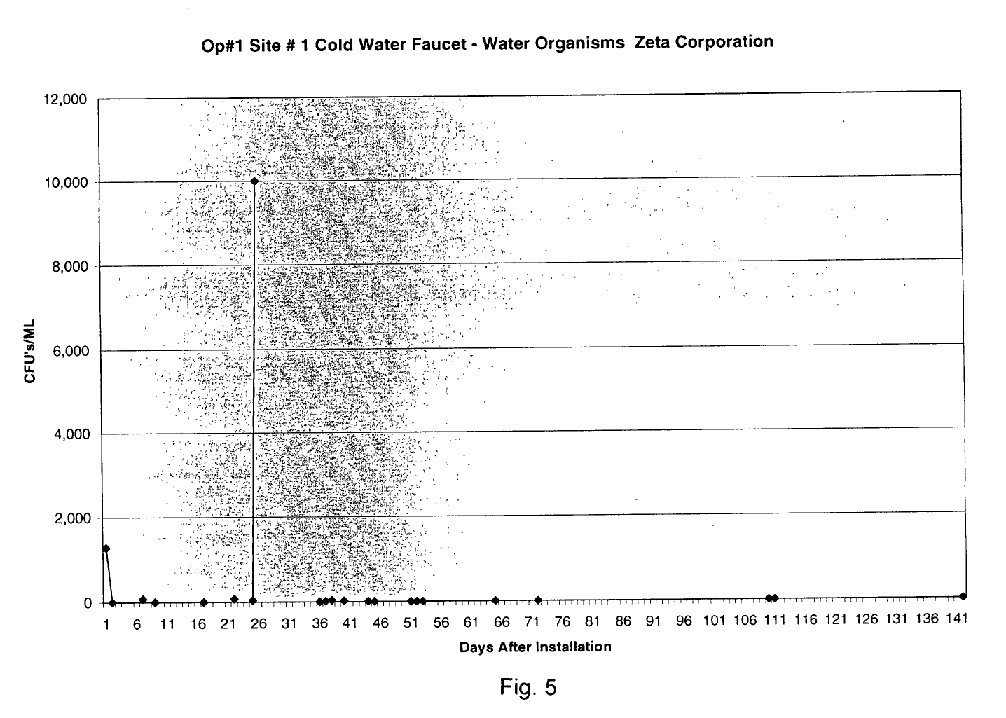

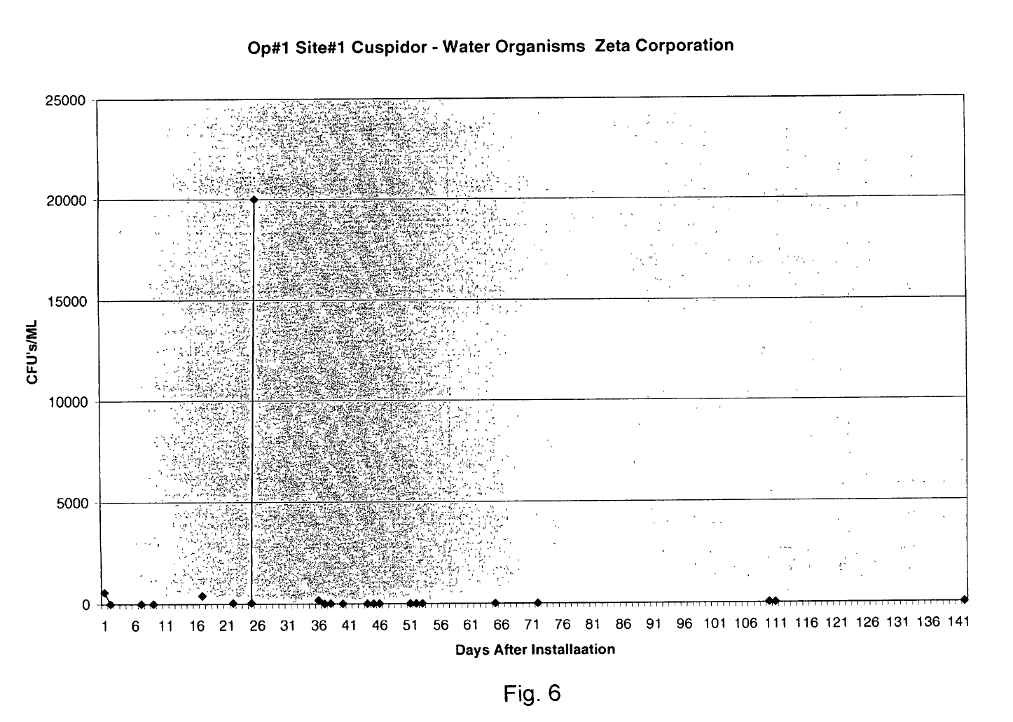

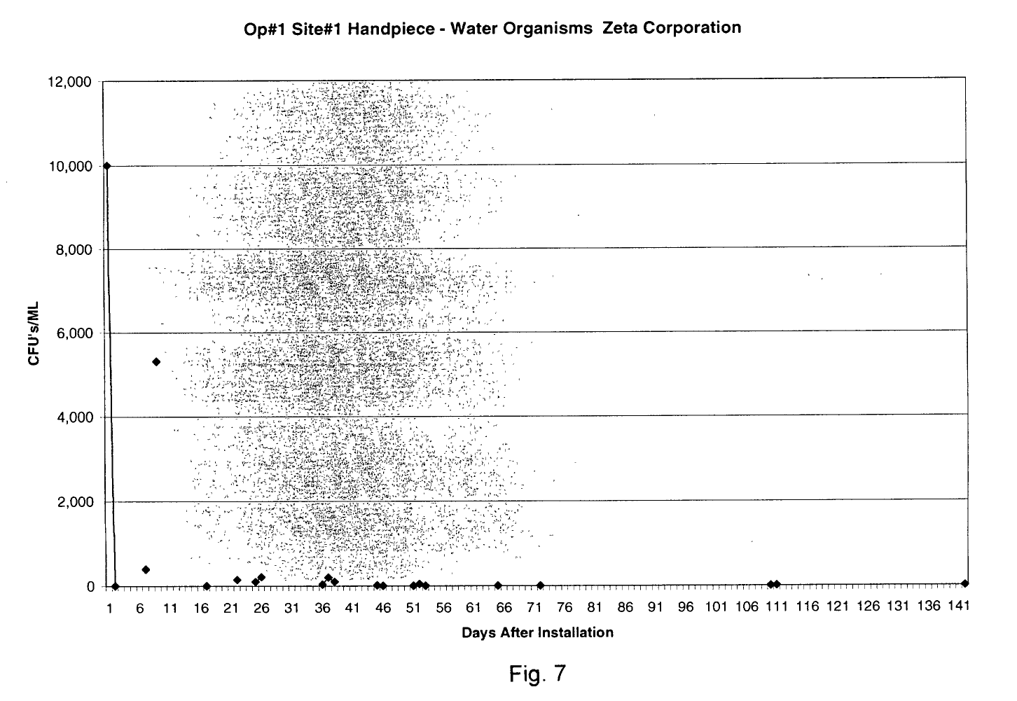

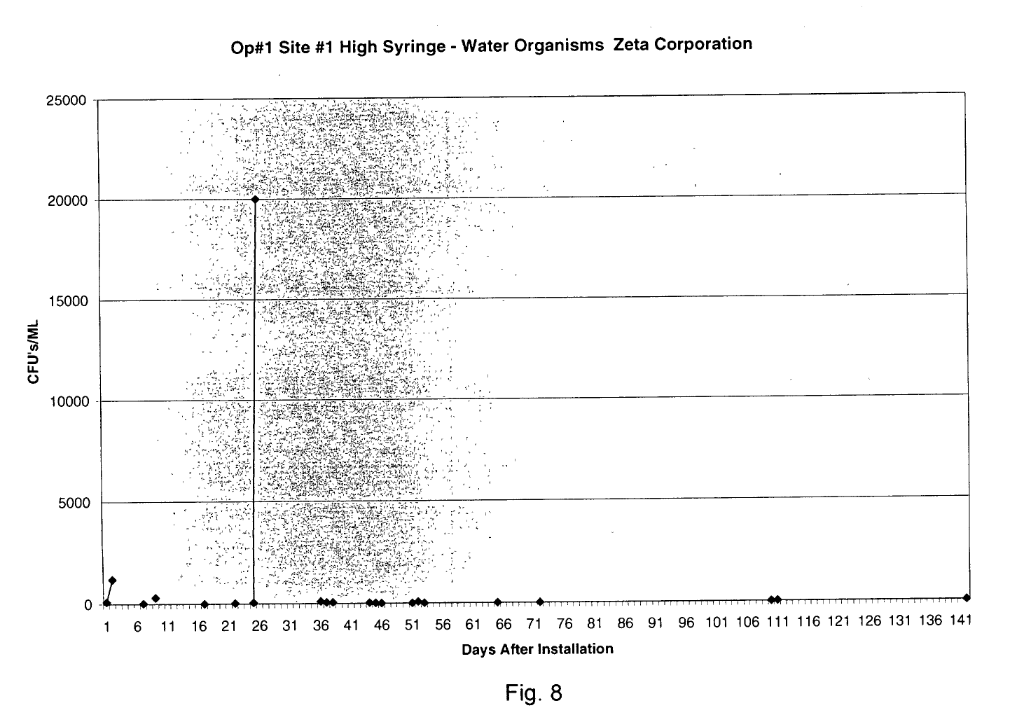

FIGS. 5-8 illustrate the change in the bacterial count of the water flowing through the DUWLs of various pieces of equipment in the first operatory obtained as a result of the application of an electrostatic field of approximately 35 kV DC over a period of several weeks.

### EXAMPLE 2

The same type of ceramic electrode and power-supply set up of Example 1 were installed in January 2002 in a second dental office in the Los Angeles area. This office included six operatories with galvanized piping about 10 years old. Analyses of the water sampled at each operatory in 1999 showed bacterial counts varying from zero to greater than 100 cfu/ml.

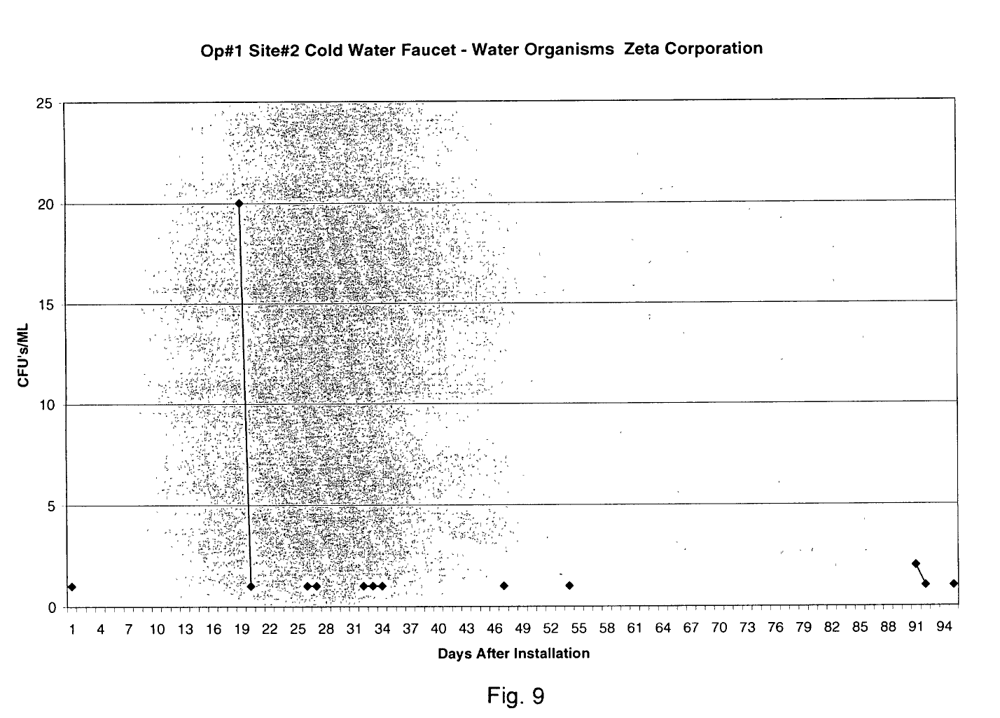

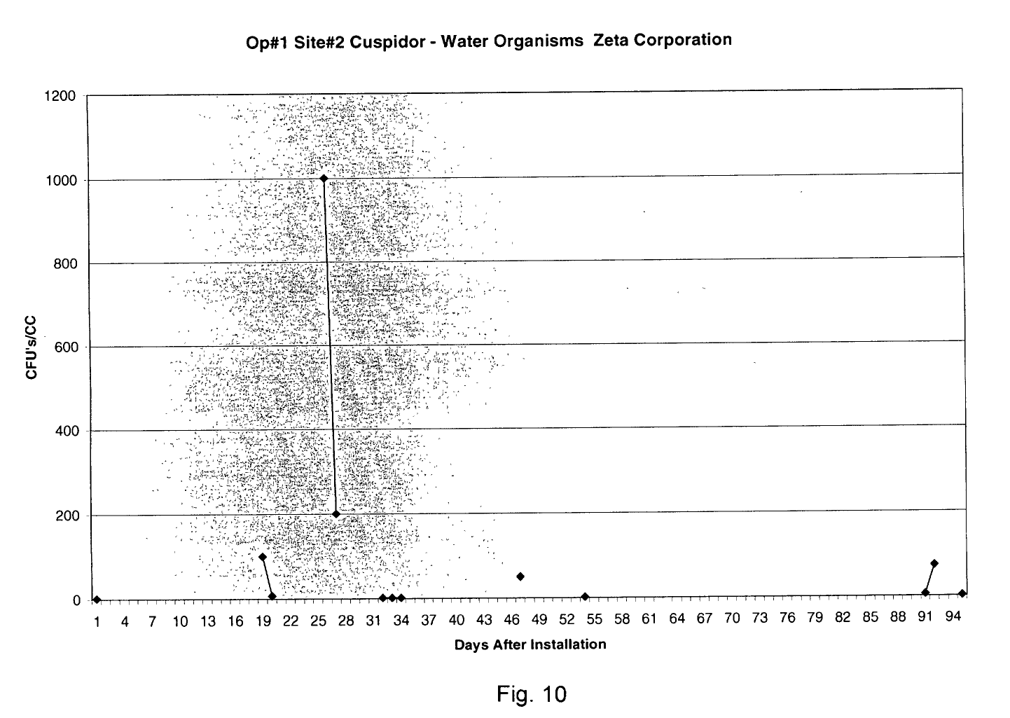

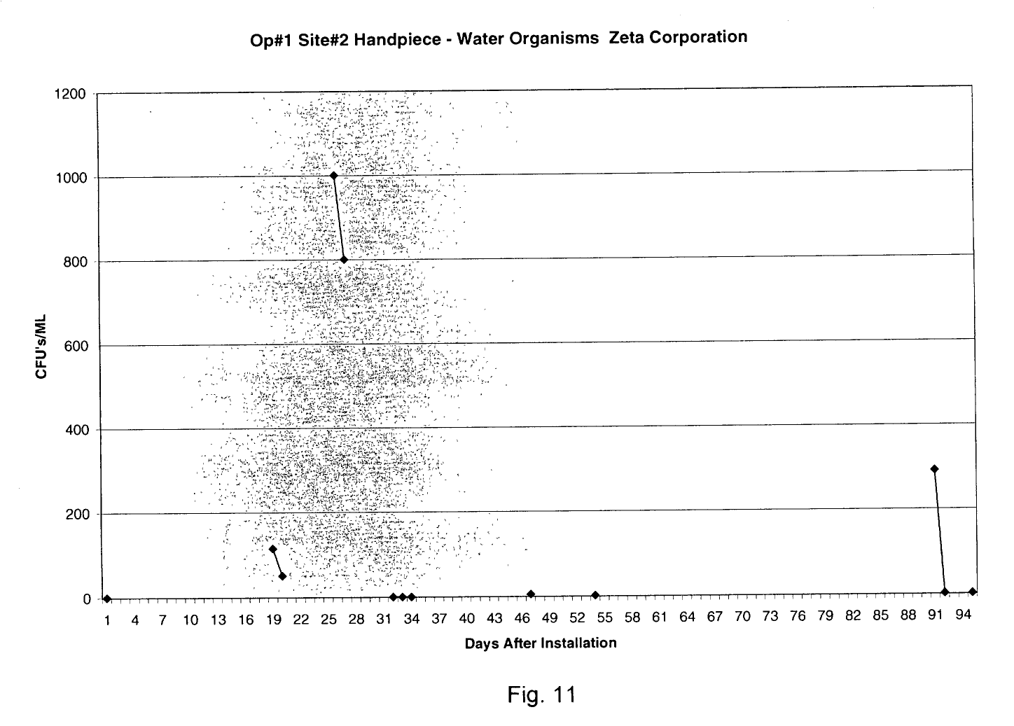

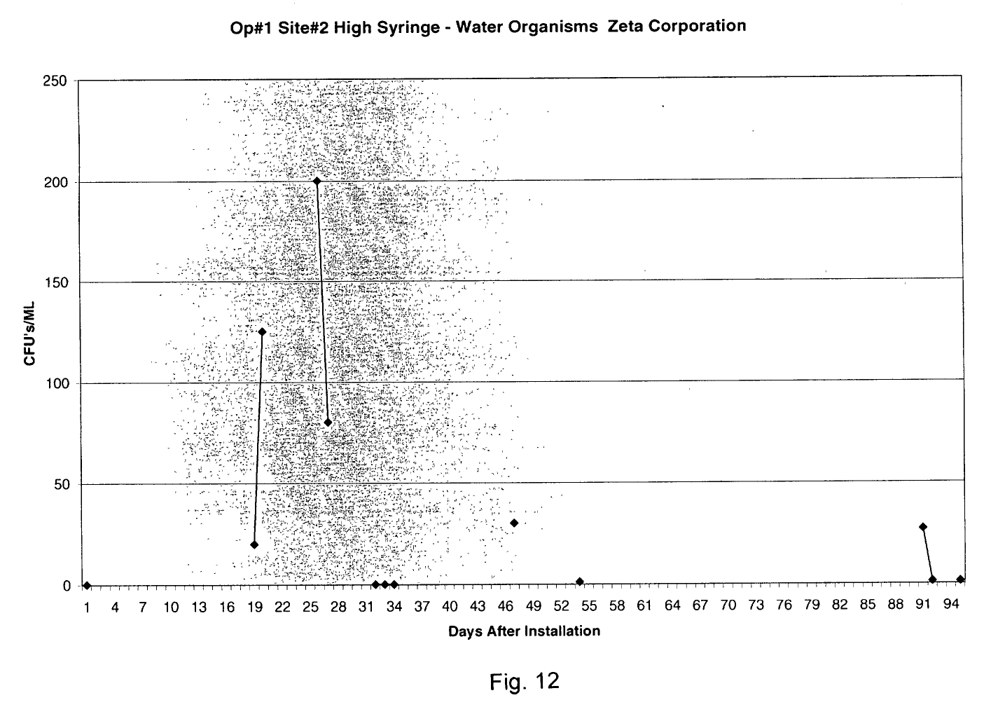

FIGS. 9-12 illustrate the change in the bacterial count of the water flowing through the DUWLs at various equipment locations in the first operatory resulting from the application of approximately 35 kV DC over a period of several weeks.

### EXAMPLE 3

The same set-up of Examples 1 and 2 was used in a third dental office in the Los Angeles area starting in February 2002. This office included six operatories with copper piping about 4 years old. Analyses of the water sampled at different locations throughout the operatories in 1997 and 2000 showed bacterial counts varying from about 96 to about 312 cfu/ml.

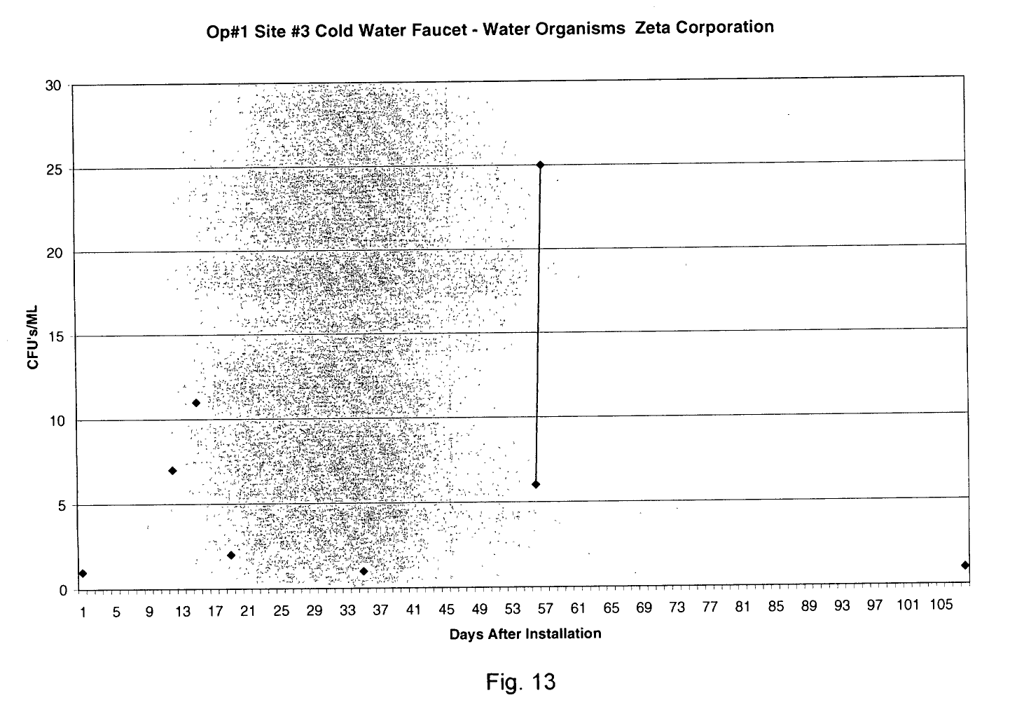

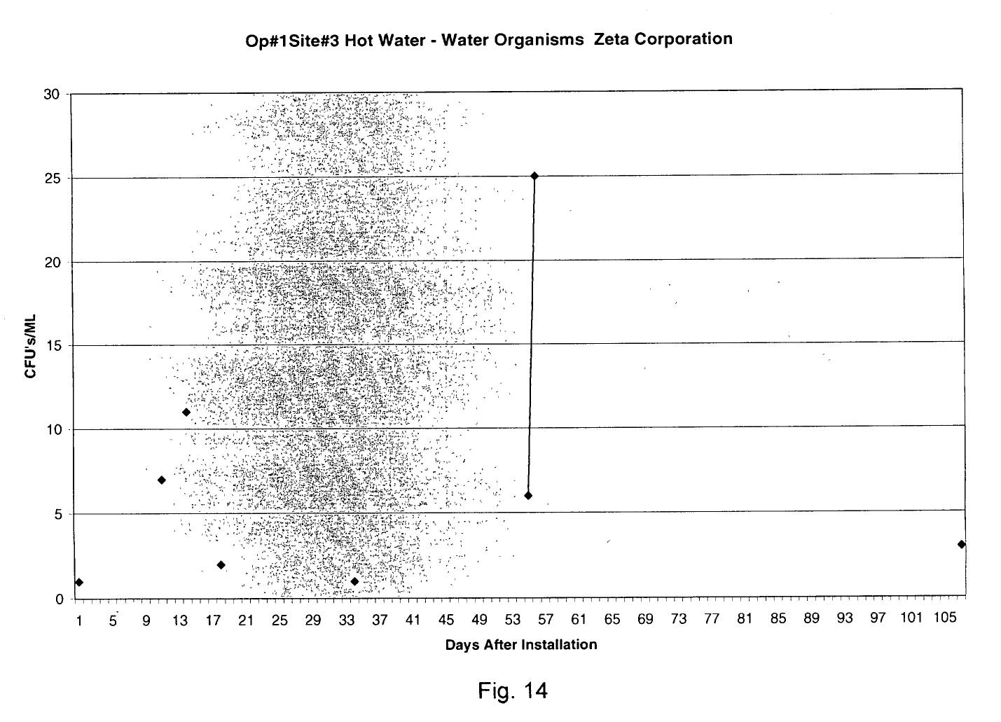

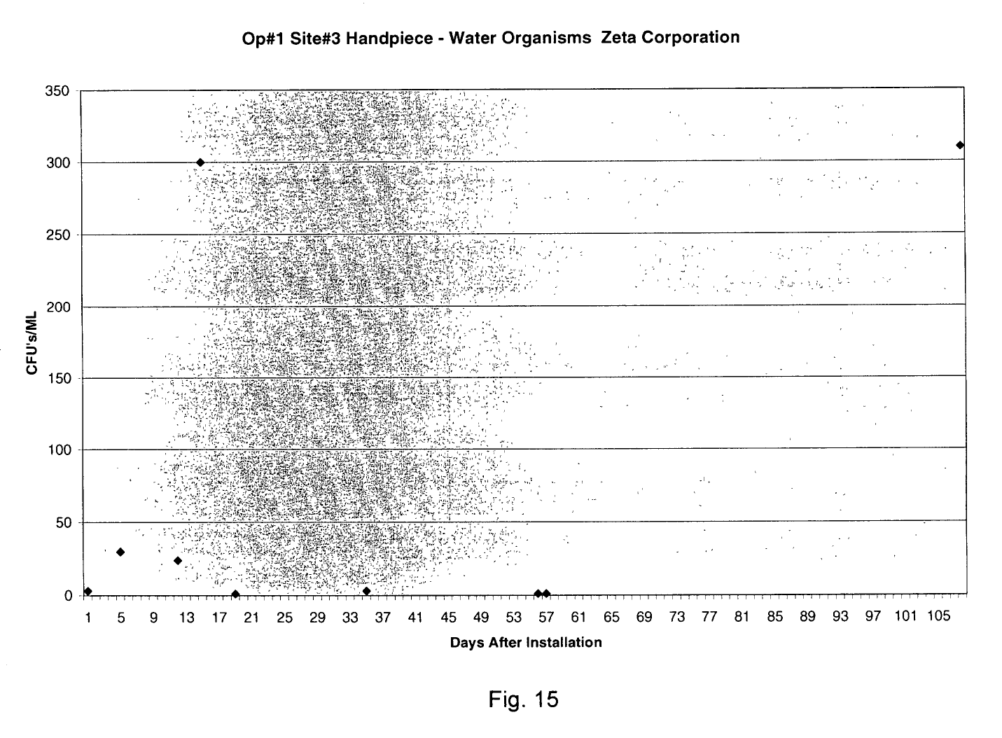

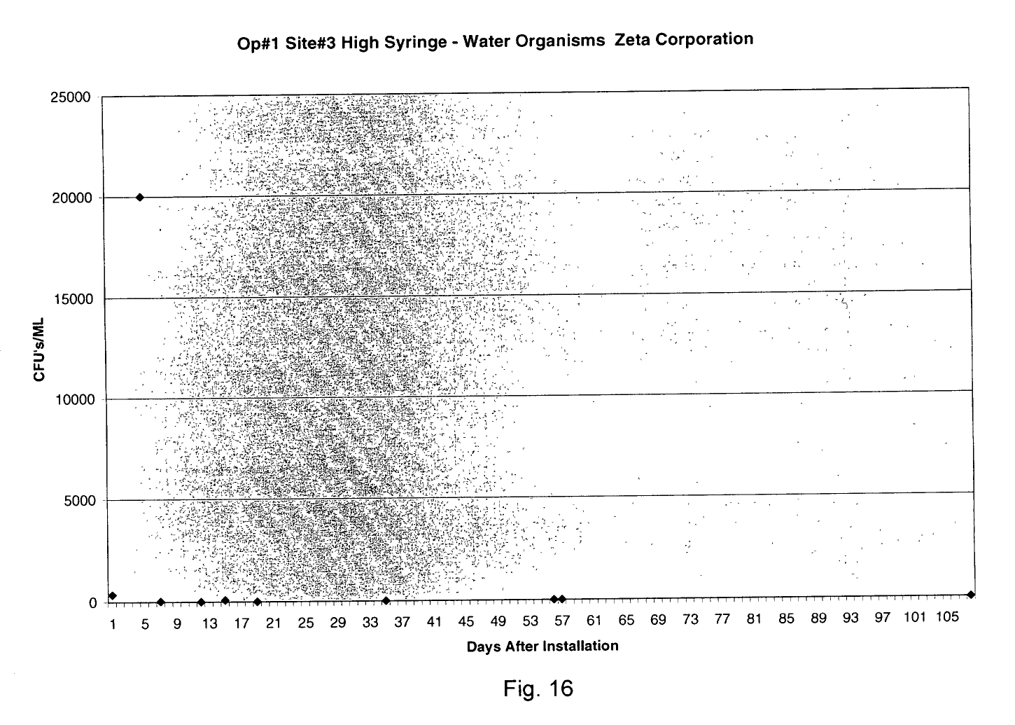

FIGS. 13-16 illustrate the change in the bacterial count of the water flowing through the DUWLs at several locations within the first operatory in this dental office obtained as a result of the application of approximately 35 kV DC over a period of several weeks.

The results of these three examples show that within the first few weeks of application each operatory experienced a large swing in bacterial counts, which is consistent with a release of bacteria with the biofilm suddenly detached from the walls of the DUWLs. Some tests showed sporadic spikes thought to be attributable to samples contaminated by recent exposure to patients. The reported results are exemplary of the outcome of the tests conducted at other locations in all 16 operatories of the three dental offices that were sampled. Taking all experimental data into account, during the first few weeks of high-voltage electrostatic-field application the bacterial counts averaged about 300 cfu/ml on the “countable” cultures, with several peaks over the 20,000 level corresponding to times when sampling is believed to have followed a recent release of biofilm from the DUWLs. In the second month, bacterial counts averaged 60 cfu/ml. After Day 60, bacterial counts averaged less than 25 cfu/ml. They continue to do so to this date. Occasional spikes in the data collected after 60 days are believed to have resulted from recent exposure to patients. All trends reported for heterotrophic bacteria were paralleled by exactly similar trends in tests performed on a smaller scale for human pathologic bacteria. Based on the similar results obtained in fighting biofilm formation in industrial settings, this effect is expected to last as long as the high-voltage capacitor is kept in place. It is noteworthy that the clearing effect of the process of the invention on biofilm was so pronounced in the dental office of Example 3 that it became necessary to reduce the operating pressure in order to control the resulting increase of water flow the DUWLS.

Thus, the process and apparatus of the invention have demonstrated that microbial counts in DUWLs can be lowered to acceptable levels and controlled indefinitely without the use of chemicals or separate water systems. Since the invention's ability to remove biofilm is exerted on all water lines when it is applied to the main water source entering a dental office, the same trends were observed at every location in the multiple operatories and offices that were tested, whether it be the hot or cold water faucets, the air/water syringes, the cuspidors, or the dental handpieces. Thus, the invention provides a rapid, economical, and lasting solution to the problem of bacterial contamination in the water system of dental offices, producing a consistent level of pelagic (free floating) bacteria less than 200 cfu/ml. This is accomplished without the need for any change in the procedures and normal routines of a conventional dental office.

The safety of high-voltage capacitance fields has already been proven by the experience gained in industrial applications, where no significant health effect has been attributed to this technology. In addition, microbiologic studies conducted to ascertain the health effects of high-voltage electrostatic fields have shown that the technology of the invention is not bactericidal. Observations in many settings confirmed that such fields cause the release of biofilm from wettable surfaces, and that their presence in appropriately sized contaminated systems promptly lowers bacterial counts dramatically. The benign nature of the technology was recently confirmed with cell cytology studies, studies of autopsied specimens in animals, conjunctival studies, sperm motility studies, and exhaustive studies on all materials used in dentistry. All of these studies consistently showed no deleterious effects on cells, animals, survival, motility, or materials.

Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent apparatus and methods.

What is claimed is:

1. A method for removing biofilm and preventing further formation thereof in a dental-unit water-line system, comprising the steps of:
applying a capacitive electrostatic generator to a body of water fed to the dental-unit water-line system;
providing an electrical ground to the-water relative to an electromotive force available for energizing the capacitive electrostatic generator; and
energizing the capacitive electrostatic generator with said electromotive force at a voltage greater than 10,000 volts DC, such that a corresponding capacitive electrostatic field is created between the generator immersed in the water and said electrical ground without a measurable current leakage from the generator in the body of water.

2. The method of claim 1, wherein said capacitive electrostatic generator comprises a dielectric tube of unibody construction having an integrally-sealed end defining an inner cavity with an inner wall; a conductive material contained within said inner cavity; an electrically-insulated sealing means for providing hermetic closure to said inner cavity; and electrical means for energizing said conductive material with a static electromotive force.

3. The method of claim 1, wherein said voltage is greater than about 30,000 volts DC.

4. The method of claim 2, wherein said voltage is greater than about 30,000 volts DC.

5. An improved dental unit having water lines connected to a water supply system for providing water thereto, the improvement comprising:
a capacitive electrostatic generator applied to the water;
an electrical ground connected to the water; and
a power supply connected to the electrostatic generator to create an electrostatic field by application of an electromotive force greater than 10,000 volts DC without measurable current leakage from the electrostatic generator in the water.

6. The apparatus of claim 5, wherein said capacitive electrostatic generator comprises a dielectric tube of unibody construction having an integrally-sealed end defining an inner cavity with an inner wall; a conductive material contained within said inner cavity; an electrically-insulated sealing means for providing hermetic closure to said inner cavity; and electrical means for energizing said conductive material with a static electromotive force.

7. The apparatus of claim 5, wherein said voltage is greater than about 30,000 volts DC.

8. The apparatus of claim 6, wherein said voltage is greater than about 30,000 volts DC.
